(19) United States
(12) Patent Application Publication
(10) Pub. No.: US 2011/0076558 A1
(43) Pub. Date: Mar. 31, 2011

(54) NON-AQUEOUS ELECTROLYTE SECONDARY CELL

(75) Inventors: Shinya Miyazaki, Naruto-shi (JP); Takeshi Chiba, Itano-gun (JP); Kenta Ishida, Naruto-shi (JP)

(73) Assignee: SANYO ELECTRIC CO., LTD., Osaka (JP)

(21) Appl. No.: 12/893,637

(22) Filed: Sep. 29, 2010

(30) Foreign Application Priority Data
Sep. 29, 2009 (JP) 2009-225317

(51) Int. Cl. H01M 10/26

(52) U.S. Cl. 429/199

(57) ABSTRACT

The present invention provides a non-aqueous electrolyte secondary cell that has high voltage, high capacity and excellent high-temperature cycle characteristics at a low cost.

The non-aqueous electrolyte secondary cell according to the present invention is characterized by that:
the positive electrode active material is LiNiₐCo_{b}Mn_{c}O₂ (wherein, a+b+c=1, 0.3≦a≦0.6, 0.3≦b≦0.6, 0.1≦c≦0.4) containing 0.4 mass % or less of a water-soluble alkali;
the non-aqueous electrolyte contains LiPF₆ as a main electrolyte salt and 0.01 mass % or more and 0.5 mass % or less of LiBF₄; and
the non-aqueous electrolyte further contains 1.5 to 5 mass % of vinylene carbonate.

### BACKGROUND OF THE INVENTION

1. Field of the Invention

The present invention relates to an improvement of a non-aqueous electrolyte secondary cell comprising lithium-containing nickel cobalt manganese composite oxide, which can intercalate and deintercalate lithium ions, as a positive electrode active material.

2. Background Art

Lithium cobalt oxide that can intercalate and deintercalate lithium ions is useful as a positive electrode active material for a non-aqueous electrolyte secondary cell. However, cobalt is subjected to restraints when used as a source because its reserve is small.

When lithium-containing nickel cobalt manganese composite oxide is used, the utilization of cobalt can be reduced compared with lithium cobalt oxide. Furthermore, lithium-containing nickel cobalt manganese composite oxide has excellent characteristics such as high voltage and high capacity, and is therefore expected to be used as a positive electrode active material that can be substituted for lithium cobalt oxide.

However, lithium-containing nickel cobalt manganese composite oxide has a problem that a water-soluble alkali tends to remain in a reaction product during its synthesizing process.

The water-soluble alkali contained in lithium-containing nickel cobalt manganese composite oxide causes an adverse effect in the cell. Therefore, a non-aqueous electrolyte secondary cell using lithium-containing nickel cobalt manganese composite oxide as a positive electrode active material is inferior to a cell using lithium cobalt oxide in high-temperature cycle characteristics. On the other hand, when the amount of the lithium source is reduced in the synthesis reaction in order to decrease the remaining water-soluble alkali, the reaction product has low charge-discharge reactivity. If such a substance is used as a positive electrode active material, a side reaction of decomposition of the electrolyte is apt to occur due to the low charge-discharge reactivity around the surface, and thus its high-temperature cycle characteristics deteriorates.

In view of the above, it is impossible to sufficiently enhance high-temperature cycle characteristics of lithium-containing nickel cobalt manganese composite oxide only by adjusting the amount of alkali used during the synthesis reaction.

The following prior art documents are presented as technologies of a non-aqueous electrolyte secondary cell using a positive electrode active material that can intercalate and deintercalate lithium ions.

### [Patent Document 1] Japanese Patent Unexamined Publication No. 10-208728

### [Patent Document 2] Japanese Patent Unexamined Publication No. 5-74455

### [Patent Document 3] Japanese Patent Unexamined Publication No. 2005-56841

### SUMMARY OF THE INVENTION

The present invention aims at improving high-temperature cycle characteristics of lithium-containing nickel cobalt manganese composite oxide serving as a positive electrode active material, and thus providing a non-aqueous electrolyte secondary cell that has high voltage, high capacity and excellent high-temperature cycle characteristics.

The present invention for resolving the above-mentioned problems is configured as follows.

A non-aqueous electrolyte secondary cell comprises a positive electrode having a positive electrode active material that can intercalate and deintercalate lithium ions, a negative electrode having a negative electrode active material that can intercalate and deintercalate lithium ions, and a non-aqueous electrolyte. The positive electrode active material is LiNiₐCO_{b}Mn_{c}O₂ (wherein: a+b+c=1, 0.3≦a≦0.6, 0.3≦b≦0.6, 0.1≦c≦0.4) containing 0.4 mass % or less of a water-soluble alkali. And the non-aqueous electrolyte contains LiPF₆ as a main electrolyte salt and 0.01 mass % or more and 0.5 mass % or less of LiBF₄.

In the present invention, a non-aqueous electrolyte secondary cell is configured by using as a positive electrode active material LiNiₐCo_{b}Mn_{c}O₂ (wherein: a+b+c=1, 0.3≦a≦0.6, 0.3≦b≦0.6, 0.1≦c≦0.4) containing 0.4 mass % or less of a water-soluble alkali and using a non-aqueous electrolyte containing LiPF₆ as a main electrolyte salt and 0.01 mass % or more and 0.5 mass % or less of LiBF₄. With this configuration, the respective components successfully interact each other to improve the disadvantage that lithium-containing nickel cobalt manganese composite oxide is inferior in high-temperature cycle characteristics. Thus, according to the present invention, there can be realized a non-aqueous electrolyte secondary cell having high voltage, high capacity and excellent high-temperature cycle characteristics.

In the above configuration, the non-aqueous electrolyte may comprise 1.5 to 5 mass % of vinylene carbonate. This configuration further enhances high-temperature cycle characteristics of the non-aqueous electrolyte secondary cell using LiNiₐCo_{b}Mn_{c}O₂ as a positive electrode active material.

In the above configuration, the negative electrode active material is a carbonaceous material having a potential of 0.1 V or less based on lithium. When a carbonaceous material having a low potential is used as a negative electrode active material, a cell voltage is increased and the utilization of a positive electrode active material and the cell capacity is enhanced. Therefore, this configuration can realize a non-aqueous electrolyte secondary cell that has higher voltage, higher capacity and more excellent high-temperature characteristics.

### EFFECT OF THE PRESENT INVENTION

According to the present invention, the respective components successfully interact each other in a balanced manner to overcome the disadvantage of inferior high-temperature cycle characteristics of lithium-containing nickel cobalt manganese composite oxide (LiNiₐCO_{b}Mn_{c}O₂), and thus the advantage thereof is exerted. Therefore, according to the present invention, there is provided a non-aqueous electrolyte secondary cell that has high voltage, high capacity and excellent high-temperature cycle characteristics at a lower cost than a cell using lithium cobalt oxide.

### DESCRIPTION OF THE PREFERRED EMBODIMENT

We will explain the embodiments of the present invention by clarifying the relationship between various test cells (No. 1 to 28, No. 30 to 32, No. 40 to 43, No. 50 to 54) including the non-aqueous electrolyte secondary cell according to the present invention and their high-temperature cycle retention rate (%).

To clarify the technology of the embodiments according to the present invention, the test cells were classified into four groups: the first test group (the test cells Nos. 1 to 28); the second test group (the test cells Nos. 30 to 32); the third test group (the test cells Nos. 40 to 43); and the fourth test group (the test cells Nos. 50 to 54). In each of the test groups, the following relationships were revealed:

### (First Test Group)

the relationship between the high-temperature cycle retention rate (%) and the elemental composition of the positive electrode active material (LiNiₐCo_{b}Mn_{c}O₂);

### (Second Test Group)

the relationship between the high-temperature cycle retention rate (%) and the amount of the water-soluble alkali in the positive electrode active material;

### (Third Test Group)

the relationship between the high-temperature cycle retention rate (%) and the concentration of LiBF₄ in the non-aqueous electrolyte;

### (Fourth Test Group)

the relationship between the high-temperature cycle retention rate (%) and the concentration of vinylene carbonate in the non-aqueous electrolyte.

### <First Test Group>

In the first experiment group, the test cells Nos. 1 to 28 (cf. Table 1) were fabricated in which the amount of the water-soluble alkali was 0.1 mass % (constant), and positive electrode active materials (LiNiₐCO_{b}Mn_{c}O₂) having 28 types of elemental compositions (a:b:c) were prepared. Then, these cells were evaluated regarding the relationship between the high-temperature cycle retention rate (%) and the elemental composition. First of all, we will explain a method for producing of the test cells.

### 1. Preparation of the Positive Electrode Active Material

First, metal elements Ni, Co and Mn, whose amounts were adjusted respectively so as to have an intended composition ratio, were dissolved into sulfuric acid. Sodium hydrogen carbonate was added to the sulfuric acid solution, and then carbonates of these metals were coprecipitated. This coprecipitation product was subjected to a thermolysis reaction to afford tricobalt tetraoxide containing Ni and Mn.

Next, the resulting tricobalt tetraoxide containing Ni and Mn was mixed with lithium carbonate in a mortar. Then, the mixture was baked in an air atmosphere at 850° C. for 20 hours to afford a baked product. This baked product was cracked in a mortar to afford lithium-containing nickel cobalt manganese composite oxide having an average particle size of 10 μm. In this way, 28 kinds (Nos. 1 to 28) of lithium-containing nickel cobalt manganese composite oxides (LiNiₐCO_{b}Mn_{c}O₂) were prepared.

### (Measurement of the Elemental Ratio)

Each amount of Li, Ni, Co and Mn in the lithium-containing nickel cobalt manganese composite oxide synthesized above was measured with Inductively Coupled Plasma analysis to determine their elemental ratio (a:b:c). The respective elemental ratios of the cells in the first test group are listed in Table 1.

### (Measurement of the Amount of the Water-Soluble Alkali)

The amount of the water-soluble alkali in the lithium-containing nickel cobalt manganese composite oxide synthesized above was measured using a neutralization titration method (Warder method). Specifically, 5 g of lithium-containing nickel cobalt manganese composite oxides (LiNiₐCO_{b}Mn_{c}O₂) was put into 50 ml of pure water and was then stirred for 1 hour. Then, the solution was filtered to remove solid components. A hydrochloric acid solution with a known concentration was dropped to the resulting filtrate until pH was 8.4, and a hydrochloric acid amount a was calculated from the amount of the dropped hydrochloric acid solution. Then, the above hydrochloric acid solution was subsequently dropped until the solution pH was 4.0, and a hydrochloric acid amount β was calculated from the amount of the additionally dropped hydrochloric acid solution.

The hydrochloric acid amount “2β” in the above measurement is corresponding (equivalent) to the amount of lithium carbonate (Li₂CO₃), and “α minus β” corresponds to the total amount of lithium hydroxide (LiOH). Thereby, the ratio of the total mass of lithium carbonate and lithium hydroxide to the mass of the positive electrode active material was defined as the amount of the water-soluble alkali in the positive electrode active material. This definition determined that all of the amounts of the water-soluble alkali in the cells of the first test group were 0.1 mass %.

It is thought that the measured lithium carbonate is derived from lithium carbonate added during the synthesis reaction and that the measured lithium hydroxide is generated by reacting the lithium source with water in the air. The above-stated neutralization titration method can determine each amount of lithium carbonate and lithium hydroxide in a lithium-containing nickel cobalt manganese composite oxide. Therefore, when the amount of lithium carbonate as a lithium source is adjusted during the synthesis reaction on the basis of the titration result, there can be obtained a lithium-containing nickel cobalt manganese composite oxide having a desired amount (0.1 mass % in this case) of water-soluble alkali therein.

### 2. Preparation of the Positive Electrode

The lithium-containing nickel cobalt manganese composite oxide (LiNiₐCo_{b}Mn_{c}O₂) prepared above was used as a positive electrode active material. Eighty-five mass parts of the lithium-containing nickel cobalt manganese composite oxide, 10 mass parts of carbon powder as a conductive agent, and 5 mass parts of polyvinylidene fluoride powder as a binder were mixed. Then, the mixture is further mixed with N-methylpyrrolidone to prepare slurry. This slurry was applied on both surfaces of an aluminium current collector with the thickness of 20 μm using a doctor blade, thus forming active material layers on both surface of the positive electrode current collector. Thereafter, the product was compressed to the thickness of 160 μm using a compression roller to afford a positive electrode with 55 mm of the short side and 500 mm of the long side.

### 3. Preparation of the Negative Electrode

Ninety-five mass parts of natural graphite powder and 5 mass parts of polyvinylidene fluoride powder were mixed. Then, the mixture is further mixed with N-methylpyrrolidone to prepare slurry. This slurry was applied on both surfaces of a copper current collector with the thickness of 18 μm using a doctor blade, thus forming active material layers. Thereafter, the product was compressed to the thickness of 155 μm using a compression roller to afford a negative electrode with 57 mm of the short side and 550 mm of the long side.

The potential of the graphite is 0.1 V based on lithium. The amounts of the active materials filled in the positive electrode and the negative electrode were adjusted such that the theoretical charge capacity ratio (negative electrode charge capacity/positive electrode charge capacity) would be 1.1 at the potential of the positive electrode active material, which served as a design reference.

### 4. Preparation of the Non-Aqueous Electrolyte

LiPF₆ and LiBF₄ were dissolved in a mixture solvent containing ethylene carbonate (EC), diethyl carbonate (DEC) and vinylene carbonate (VC) to prepare a non-aqueous electrolyte (also referred to as electrolyte solution) whose mass ratio is EC 30%; DEC 55.3%; VC 2.5%; LiPF₆ 12%; and LiBF₄ 0.2% relative to the total mass (100%).

### 5. Fabrication of the Cell

A polypropylene microporous film as a separator was sandwiched between the positive electrode and the negative electrode, and was then wound to form an electrode assembly. This electrode assembly was housed in a bottomed cylindrical can with 65 mm of height and 18 mm of diameter. Thereafter, the above non-aqueous electrolyte was poured into the can. In this way, the first test cells Nos. 1 to 28 listed in Table 1 were fabricated.

### <High-Temperature Cycle Test>

A high-temperature cycle test for determining high-temperature cycle retention rates (%) of the above-mentioned test cells was performed. In this high-temperature cycle test, the cells were charged at a constant current of 1600 mA to a voltage of 4.2 V under a temperature environment of 70° C., and then charged at a constant voltage of 4.2 V to a current of 30 mA. Next, the cells were discharged at a constant current of 1600 mA until the voltage reached 2.7V under the same temperature environment. These series of charge-discharge operations, which are referred to as one cycle, were repeated for 300 cycles. The ratio (%) of the discharge capacity at the 300th cycle to that at the first cycle was defined as the high-temperature cycle retention rates (%).

The results of the first test group are listed in Table 1. Table 1 reveals the relationship between the elemental composition of the positive electrode active material (LiNiₐCO_{b}Mn_{c}O₂) and the high-temperature cycle retention rate (%).

TABLE 1
(The relationship between the elemental composition and the
high-temperature cycle characteristics)

| | Water-soluble | LiBF₄ | | | | |
|---|---|---|---|---|---|---|
| | Alkali Amount in | Concentration | | | | High-temperature |
| Test | Positive Electrode | in Non-aqueous | | | | Cycle Retention |
| Cell | Active Material | Electrolyte | (LiNiₐCo_{b}Mn_{c}O₂) | | | Rate |
| No. | (Mass %) | (Mass %) | a | b | c | (%) |
| 1 | 0.1 | 0.2 | 0.2 | 0.2 | 0.6 | 70 |
| 2 | 0.1 | 0.2 | 0.3 | 0.2 | 0.5 | 72 |
| 3 | 0.1 | 0.2 | 0.4 | 0.2 | 0.4 | 73 |
| 4 | 0.1 | 0.2 | 0.5 | 0.2 | 0.3 | 74 |
| 5 | 0.1 | 0.2 | 0.6 | 0.2 | 0.2 | 74 |
| 6 | 0.1 | 0.2 | 0.7 | 0.2 | 0.1 | 72 |
| 7 | 0.1 | 0.2 | 0.8 | 0.2 | 0 | 70 |
| 8 | 0.1 | 0.2 | 0.2 | 0.3 | 0.5 | 72 |
| 9 | 0.1 | 0.2 | 0.3 | 0.3 | 0.4 | 83* |
| 10 | 0.1 | 0.2 | 0.4 | 0.3 | 0.3 | 83* |
| 11 | 0.1 | 0.2 | 0.5 | 0.3 | 0.2 | 83* |
| 12 | 0.1 | 0.2 | 0.6 | 0.3 | 0.1 | 83* |
| 13 | 0.1 | 0.2 | 0.7 | 0.3 | 0 | 72 |
| 14 | 0.1 | 0.2 | 0.2 | 0.4 | 0.4 | 74 |
| 15 | 0.1 | 0.2 | 0.3 | 0.4 | 0.3 | 85** |
| 16 | 0.1 | 0.2 | 0.4 | 0.4 | 0.2 | 84* |
| 17 | 0.1 | 0.2 | 0.5 | 0.4 | 0.1 | 84* |
| 18 | 0.1 | 0.2 | 0.6 | 0.4 | 0 | 74 |
| 19 | 0.1 | 0.2 | 0.2 | 0.5 | 0.3 | 77 |
| 20 | 0.1 | 0.2 | 0.3 | 0.5 | 0.2 | 85** |
| 21 | 0.1 | 0.2 | 0.4 | 0.5 | 0.1 | 84* |
| 22 | 0.1 | 0.2 | 0.5 | 0.5 | 0 | 76 |
| 23 | 0.1 | 0.2 | 0.2 | 0.6 | 0.2 | 77 |
| 24 | 0.1 | 0.2 | 0.3 | 0.6 | 0.1 | 84* |
| 25 | 0.1 | 0.2 | 0.4 | 0.6 | 0 | 76 |
| 26 | 0.1 | 0.2 | 0.2 | 0.7 | 0.1 | 77 |
| 27 | 0.1 | 0.2 | 0.3 | 0.7 | 0 | 76 |
| 28 | 0.1 | 0.2 | 0.2 | 0.8 | 0 | 76 |

The test cells Nos. 1 to 7 listed in Table 1 were non-aqueous electrolyte secondary cells in which the ratio of Co (b) was set to 0.2 (constant), the ratios of Ni and Mn (a, c) were varied, and all other conditions were identical. The high-temperature cycle retention rates of the test cells Nos. 1 to 7 are 70 to 74%, which are low values.

The test cells Nos. 8 to 13 listed in Table 1 were non-aqueous electrolyte secondary cells in which the ratio of Co (b) was set to 0.3 (constant), the ratios of Ni and Mn (a, c) were varied, and all other conditions were identical. In the test cells Nos. 8 to 13, while the test cells Nos. 9 to 12 (a: 0.3 to 0.6) showed good high-temperature cycle retention rates of 83%, the test cells No. 8 where a=0.2 and No. 13 where c=0 (a=0.7) showed inferior high-temperature cycle retention rates (72%).

The test cells Nos. 14 to 18 listed in Table 1 were non-aqueous electrolyte secondary cells in which the ratio of Co (b) was set to 0.4 (constant), the ratios of Ni and Mn (a, c) were varied, and all other conditions were identical. In the test cells Nos. 14 to 18, while the test cells Nos. 15 to 17 (a: 0.3 to 0.5) showed good high-temperature cycle retention rates of 84 or 85%, the test cells No. 14 where a=0.2 and No. 18 where c=0 (a=0.6) showed inferior high-temperature cycle retention rates (both 74%).

The test cells Nos. 19 to 22 listed in Table 1 were non-aqueous electrolyte secondary cells in which the ratio of Co (b) was set to 0.5 (constant), the ratios of Ni and Mn (a, c) were varied, and all other conditions were identical. In the test cells Nos. 19 to 22, while the test cells Nos. 20 and 21 (a: 0.3 and 0.4) showed good high-temperature cycle retention rates of 84 or 85%, the test cells No. 19 where a=0.2 and No. 22 where c=0 (a=0.5) showed inferior high-temperature cycle retention rate (77% and 76%, respectively).

The test cells Nos. 23 to 25 listed in Table 1 were non-aqueous electrolyte secondary cells in which the ratio of Co (b) was set to 0.6 (constant), the ratios of Ni and Mn (a, c) were varied, and all other conditions were identical. In the test cells Nos. 23 to 25, while the test cell No. 24 (a=0.3) showed good high-temperature cycle retention rates of 84%, the test cells No. 23 where a=0.2 and No. 25 where c=0 (a=0.4) showed inferior high-temperature cycle retention rates (77% and 76%, respectively).

The test cells Nos. 26 and 27 listed in Table 1 were non-aqueous electrolyte secondary cells in which the ratio of Co (b) was set to 0.7 (constant), the ratios of Ni and Mn (a, c) were varied, and all other conditions were identical. The test cells No. 26 where a=0.2 and No. 27 where c=0 (a=0.3) were inferior in high-temperature cycle retention rate (77% and 76%, respectively).

The test cell No. 28 listed in Table 1 was non-aqueous electrolyte secondary cells in which the ratio of Co (b) was set to 0.8 and the ratios of Ni (a) and Mn (c) were set to 0.2 and 0, respectively, and all other conditions were identical to the cells Nos. 1 to 27. The test cell No. 28 was inferior in high-temperature cycle retention rate (76%).

The above results shown in Table 1 reveal that the high-temperature cycle retention rate is enhanced when the variables (a, b and c) of the lithium-containing nickel cobalt manganese composite oxide (LiNiₐCO_{b}Mn_{c}O₂) meet the following formulas:

a+b+c=1, 0.3≦a≦0.6, 0.3≦b≦0.6, 0.1≦c≦0.4.

### <Second Test Group>

In the second test group, non-aqueous electrolyte secondary cells (Nos. 30 to 32) were fabricated using LiNi_{0.3}Co_{0.4}Mn_{0.3}O₂ and the water-soluble alkali having three types of amounts. Their elemental composition and non-aqueous electrolyte were identical to those of the test cell No. 15. Then, these cells and the test cell No. 15 were evaluated regarding the relationship between the high-temperature cycle retention rate (%) and the amount of water-soluble alkali in the positive electrode active material.

The results are shown in Table 2. The test cells Nos. 30 to 32 were fabricated in the same manner as the test cell No. 15 fabricated in the first test group, expect for varying the additional amounts of the water-soluble lithium as a lithium source in the synthesis reaction.

TABLE 2
(The relationship between the amount of the water-soluble
alkali and the high-temperature cycle characteristics)

| | Water-soluble | LiBF₄ | | | | |
|---|---|---|---|---|---|---|
| | Alkali Amount in | Concentration in | | | | High-temperature |
| Test | Positive Electrode | Non-aqueous | | | | Cycle Retention |
| Cell | Active Material | Electrolyte | (LiNiₐCo_{b}Mn_{c}O₂) | | | Rate |
| No. | (Mass %) | (Mass %) | a | b | c | (%) |
| 15 | 0.1 | 0.2 | 0.3 | 0.4 | 0.3 | 85** |
| 30 | 0.01 | 0.2 | 0.3 | 0.4 | 0.3 | 85** |
| 31 | 0.4 | 0.2 | 0.3 | 0.4 | 0.3 | 84* |
| 32 | 0.5 | 0.2 | 0.3 | 0.4 | 0.3 | 76 |

In Table 2, the test cell No. 32 including 0.5 mass % of the water-soluble alkali shows 76% of high-temperature cycle retention rate, which is low. However, the other cells are excellent. In all Tables herein, the amount of the water-soluble alkali is represented in a mass percentage in the case of defining the total mass of the positive electrode active material including the water-soluble alkali as 100%.

The results shown in Table 2 reveal that the amount of the water-soluble alkali in lithium-containing nickel cobalt manganese composite oxides (LiNiₐCo_{b}Mn_{c}O₂) must be less than 0.4 mass %.

### <Third Test Group>

In the third test group, non-aqueous electrolyte secondary cells (Nos. 40 to 43) were fabricated under the condition in which their elemental composition and the amount of water-soluble alkali were identical to those of the test cell No. 15 but only the concentration of LiBF₄ (mass % based on the total non-aqueous electrolyte) was varied. Then, these cells and the test cell No. 15 were evaluated regarding the relationship between the high-temperature cycle retention rate (%) and the concentration of LiBF₄. The results are shown in Table 3. The variation in the concentration of LiBF₄ was adjusted by increasing or decreasing LiPF₆ so as not to influence the composition of the other components.

TABLE 3
(The relationship between the concentration of LiBF₄ and the
high-temperature cycle characteristics)

| | Water-soluble | LiBF₄ | | | | |
|---|---|---|---|---|---|---|
| | Alkali Amount in | Concentration | | | | High-temperature |
| Test | Positive Electrode | in Non-aqueous | | | | Cycle Retention |
| Cell | Active Material | Electrolyte | (LiNiₐCo_{b}Mn_{c}O₂) | | | Rate |
| No. | (Mass %) | (Mass %) | a | b | c | (%) |
| 40 | 0.1 | 0 | 0.3 | 0.4 | 0.3 | 70 |
| 41 | 0.1 | 0.01 | 0.3 | 0.4 | 0.3 | 83* |
| 15 | 0.1 | 0.2 | 0.3 | 0.4 | 0.3 | 85** |
| 42 | 0.1 | 0.5 | 0.3 | 0.4 | 0.3 | 85** |
| 43 | 0.1 | 0.6 | 0.3 | 0.4 | 0.3 | 77 |

In Table 3, the test cell No. 40 including no LiBF₄ and the test cell No. 43 including 0.6 mass % of LiBF₄ show inferior high-temperature cycle retention rate, i.e. 70% and 77%, respectively. In contrast, the test cells Nos. 41 and 42 including 0.01 and 0.5 mass % of LiBF₄ show excellent high-temperature cycle retention rate, i.e. 83% and 85%, respectively.

The results shown in Table 3 reveal that the concentration of LiBF₄ in the non-aqueous electrolyte must be 0.01 to 0.5 mass %.

### <Fourth Test Group>

In the fourth test group, non-aqueous electrolyte secondary cells (Nos. 50 to 54) were fabricated under the condition as follows:
the amount of the water-soluble alkali contained in LiNiₐCO_{b}Mn_{c}O₂ was 0.1 mass %;
the ratio a/b/c in LiNiₐCo_{b}Mn_{c}O₂ was 0.3/0.4/0.3;
the concentration of LiBF₄ in the non-aqueous electrolyte was 0.2 mass % (constant); and
the concentration of vinylene carbonate in the non-aqueous electrolyte was varied (1, 1.5, 2.9, 5 or 6 mass %).

Then, these cells were evaluated regarding the relationship between the high-temperature cycle retention rate (%) and the concentration of vinylene carbonate in the non-aqueous electrolyte. The results are shown in Table 4. The variation in the concentration of vinylene carbonate was adjusted by increasing or decreasing diethyl carbonate so as not to influence the composition of the other components.

TABLE 4
(The relationship between the concentration of vinylene
carbonate and the high-temperature cycle characteristics)

| | Water-soluble | | | | | | |
|---|---|---|---|---|---|---|---|
| | Alkali | | Vinylene | | | | |
| | Amount in | LiBF₄ | Carbonate | | | | |
| | Positive | Concentration | Concentration | | | | |
| | Electrode | in | in | | | | High-temperature |
| Test | Active | Non-aqueous | Non-aqueous | | | | Cycle Retention |
| Cell | Material | Electrolyte | Electrolyte | (LiNiₐCo_{b}Mn_{c}O₂) | | | Rate |
| No. | (Mass %) | (Mass %) | (Mass %) | a | b | c | (%) |
| 50 | 0.1 | 0.2 | 1 | 0.3 | 0.4 | 0.3 | 83* |
| 51 | 0.1 | 0.2 | 1.5 | 0.3 | 0.4 | 0.3 | 85** |
| 52 | 0.1 | 0.2 | 2.9 | 0.3 | 0.4 | 0.3 | 85** |
| 53 | 0.1 | 0.2 | 5 | 0.3 | 0.4 | 0.3 | 85** |
| 54 | 0.1 | 0.2 | 6 | 0.3 | 0.4 | 0.3 | 83* |

According to Table 4, all of the non-aqueous electrolyte secondary cells are excellent in high-temperature cycle retention rate. Among them, the test cell Nos. 51 to 53 whose concentrations of vinylene carbonate were 1.5 to 5 mass % significantly show excellent high-temperature cycle retention rate. Therefore, it is clearly found that vinylene carbonate is preferably contained in the electrolyte at the concentration of 1.5 to 5 mass %.

In view of all above results, it can be demonstrated that the following configuration provides the cell that is excellent in high-temperature cycle retention rate:
LiNiₐCo_{b}Mn_{c}O₂ (wherein, a+b+c=1, 0.3≦a≦0.6, 0.3≦b≦0.6, 0.1≦c≦0.4) containing 0.4 mass % or less of a water-soluble alkali is used as a positive electrode active material; and
a non-aqueous electrolyte is used which contains LiPF₆ as a main electrolyte salt and 0.01 mass % or more and 0.5 mass % or less of LiBF₄.

In addition, it can be demonstrated that an addition of 1.5 to 5 mass % of vinylene carbonate to the non-aqueous electrolyte further enhances high-temperature cycle retention rate.

The present invention has achieved based on the above-stated test results. Therefore, the test cells Nos. 9-12, 15-17, 20-21, 24, 30-31, 41-42, 50-54 are corresponding to Examples of the present invention, and the test cells Nos. 1-8, 13-14, 18-19, 22-23, 25-28, 32, 40 and 43 are corresponding to Comparative Examples.

Regarding the completed cell, the amount of the water-soluble alkali in the positive electrode active material (LiNiₐCo_{b}Mn_{c}O₂) can be determined as follows. The completed cell is broken up in a dehumidified atmosphere, and then the active material is removed from the positive electrode. The resulting active material is washed with diethyl carbonate, and dried. This dried substance is weighted and subjected to the above-stated neutralization titration method. The resulting value shows the amount of the water-soluble alkali in the positive electrode active material (LiNiₐCo_{b}Mn_{c}O₂) that is a component of the present invention.

The negative electrode according to the present invention has only to comprise a negative electrode active material that can intercalate and deintercalate lithium ions. The kind of the negative electrode active material is not limited, but it is preferable to use a carbonaceous material that can intercalate and deintercalate lithium ions. Especially, it is more preferable to use a carbonaceous material having a potential of 0.1 V or less based on lithium because a carbonaceous material having low potential increases cell voltage, and enhances the utilization of the positive electrode active material and the capacity of the cell.

Examples of the carbonaceous materials include natural graphite, artificial graphite, carbon black, coke, glassy carbons, carbon fibers, and one kind or a combination of sintered bodies thereof.

The present invention provides a non-aqueous electrolyte secondary cell and that has high voltage, high capacity and excellent high-temperature cycle characteristics at a lower cost than a cell using lithium cobalt oxide, thus providing high industrial applicability.

What is claimed is:

1. A non-aqueous electrolyte secondary cell comprising:
a positive electrode containing a positive electrode active material that can intercalate and deintercalate lithium ions;
a negative electrode containing a negative electrode active material that can intercalate and deintercalate lithium ions; and
a non-aqueous electrolyte;
wherein
the positive electrode active material is LiNiₐCo_{b}Mn_{c}O₂ (wherein, a+b+c=1, 0.3≦a≦0.6, 0.3≦b≦0.6, 0.1≦c≦0.4) containing 0.4 mass % or less of a water-soluble alkali; and
the non-aqueous electrolyte contains LiPF₆ as a main electrolyte salt and 0.01 mass % or more and 0.5 mass % or less of LiBF₄.

2. The non-aqueous electrolyte secondary cell of claim 1, wherein
the non-aqueous electrolyte contains 1.5 to 5 mass % of vinylene carbonate.

3. The non-aqueous electrolyte secondary cell of claim 2, wherein
the negative electrode active material is a carbonaceous material having a potential of 0.1 V or less based on lithium.
